(19) United States
(12) Patent Application Publication
(10) Pub. No.: US 2021/0061070 A1
(43) Pub. Date: Mar. 4, 2021

(54) Windshield Dimming Assembly

(71) Applicant: Ryan Dolson, Denver, CO (US)

(72) Inventor: Ryan Dolson, Denver, CO (US)

(21) Appl. No.: 16/560,411

(22) Filed: Sep. 4, 2019

(51) Int. Cl. B60J 3/04

(52) U.S. Cl. CPC B60J 3/04; G06F 3/013

(57) ABSTRACT

A windshield dimming assembly for automatically dimming a windshield in a vehicle includes a windshield that is positioned in a vehicle. A dimming membrane is positioned within the windshield and the dimming membrane has a plurality of sectors therein. Selected ones of the sectors of the dimming membrane is opaque to protect a driver's eyes from bright light. A light camera is coupled to the vehicle to detect light shining onto the windshield. An eye camera is positioned within the vehicle to record the driver's eyes. A control unit is coupled to the vehicle and the control unit turns on the selected sectors of the dimming membrane that correspond to the driver's line of sight. In this way the driver's eyes are protected from bright light.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to dimming device and more particularly pertains to a new dimming device for automatically dimming a windshield in a vehicle.

### (2) Description of Related Art Including Information Disclosed Under 37 CFR 1.97 and 1.98

The prior art relates to dimming device.

### BRIEF SUMMARY OF THE INVENTION

An embodiment of the disclosure meets the needs presented above by generally comprising a windshield that is positioned in a vehicle. A dimming membrane is positioned within the windshield and the dimming membrane has a plurality of sectors therein. Selected ones of the sectors of the dimming membrane is opaque to protect a driver's eyes from bright light. A light camera is coupled to the vehicle to detect light shining onto the windshield. An eye camera is positioned within the vehicle to record the driver's eyes. A control unit is coupled to the vehicle and the control unit turns on the selected sectors of the dimming membrane that correspond to the driver's line of sight. In this way the driver's eyes are protected from bright light.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an interior view of a windshield dimming assembly according to an embodiment of the disclosure.

FIG. 2 is a back view of an embodiment of the disclosure.

FIG. 3 is a perspective in-use view of an embodiment of the disclosure.

FIG. 4 is a cross sectional view taken along line 4-4 of FIG. 2 of an embodiment of the disclosure.

### DETAILED DESCRIPTION OF THE INVENTION

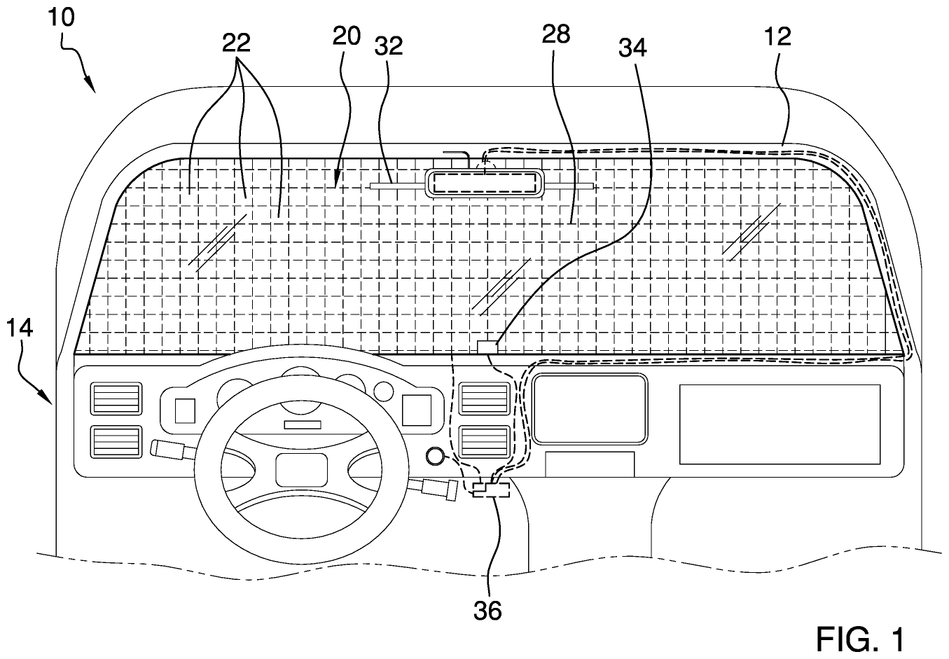

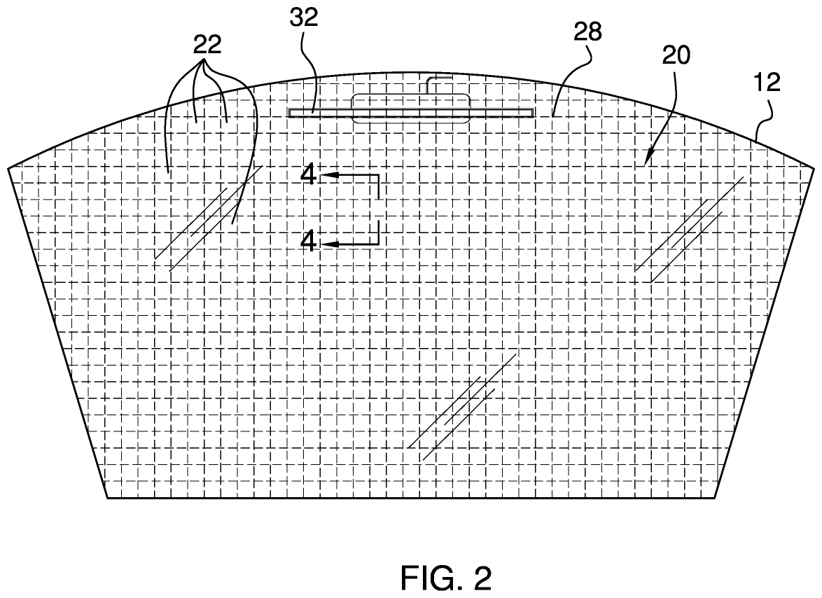

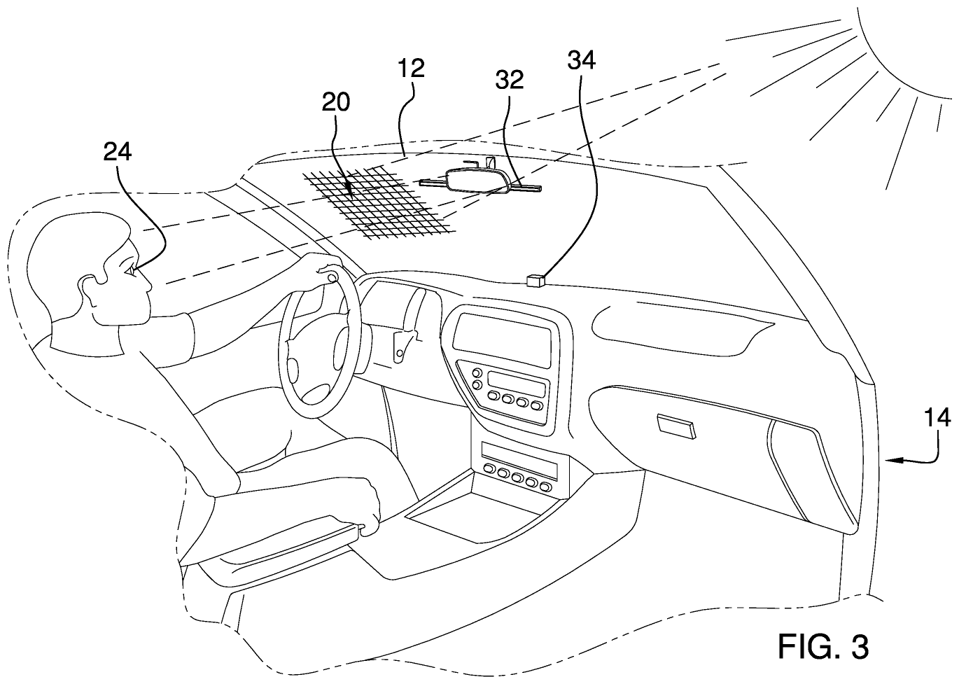

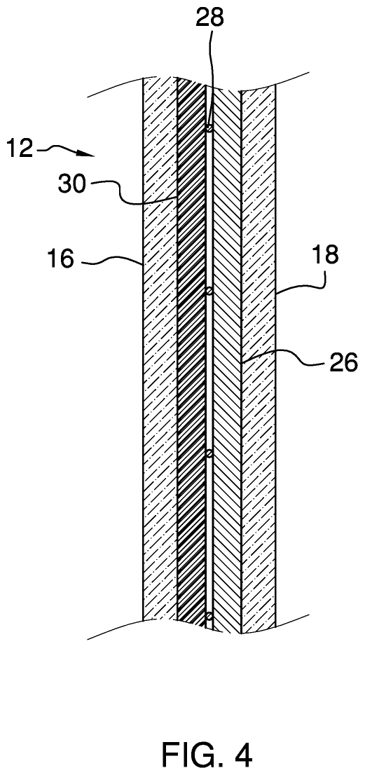

With reference now to the drawings, and in particular to FIGS. 1 through 4 thereof, a new dimming device embodying the principles and concepts of an embodiment of the disclosure and generally designated by the reference numeral 10 will be described.

As best illustrated in FIGS. 1 through 4, the windshield dimming assembly 10 generally comprises a windshield 12 that is positioned in a vehicle 14. The windshield 12 has an outer pane 16 and an inner pane 18. The vehicle 14 may be a passenger vehicle, a cargo vehicle or any other motor vehicle that is driven on public roadways. Additionally, the windshield 12 is constructed to conform to state and federal traffic safety laws.

A dimming membrane 20 is positioned within the windshield 12 and the dimming membrane 20 has a plurality of sectors 22 therein. Each of the sectors 22 is translucent when the dimming membrane 20 is turned off. In this way light can pass uninhibited through the windshield 12. Selected ones of the sectors 22 of the dimming membrane 20 are opaque when the dimming membrane 20 is turned on. In this way the selected sectors 22 protect a driver's eyes 24 from bright light during driving. The dimming membrane 20 is positioned between the inner pane 18 and the outer pane 16 of the windshield 12.

The dimming membrane 20 comprises an OLED sheet 26 that is positioned against the inner pane 18. The OLED sheet 26 completely covers the inner pane 18. Additionally, the OLED sheet 26 receives an off input and an on input. The OLED sheet 26 is translucent when the OLED sheet 26 receives the off input. Moreover, the OLED sheet 26 darkens when the OLED sheet 26 receives the on input.

A grid 28 is positioned against the OLED sheet 26 and the grid 28 completely covers the OLED sheet 26. The grid 28 is comprised of an electrically conductive material and the grid 28 is in electrical communication with the OLED sheet 26. Additionally, the grid 28 defines the plurality of sectors 22. A polymeric sheet 30 is positioned against the outer pane 16 such that the grid 28 is compressed between the OLED sheet 26 and the polymeric sheet 30. The polymeric sheet 30 is comprised of a translucent material and the polymeric sheet 30 is comprised of a shatter resistant material.

A light camera 32 is coupled to the vehicle 14. The light camera 32 is directed forwardly from the vehicle 14 to detect light shining onto the windshield 12. The light camera 32 may comprise a digital video camera or the like. An eye camera 34 is positioned within the vehicle 14. The eye camera 34 is directed toward the driver's eyes 24 to record the driver's eyes 24. Additionally, the eye camera 34 may comprise a digital video camera or the like.

A control unit 36 is provided and the control unit 36 is coupled to the vehicle 14. Each of the dimming membrane 20, the light camera 32 and the eye camera 34 is electrically coupled to the control unit 36. The control unit 36 analyzes the light detected by the light camera 32 and the control unit 36 determines the driver's line of sight detected by the eye camera 34. The control unit 36 turns on the selected sectors 22 of the dimming membrane 20 that corresponds to the driver's line of sight. In this way only a portion of the windshield 12 will be dimmed as opposed to dimming the entire windshield 12.

Each of the grid 28 and the OLED sheet 26 is electrically coupled to the control unit 36. The control circuit communicates the on input to the OLED sheet 26 when the light camera 32 detects light above a pre-determined trigger intensity. The pre-determined trigger intensity may be an intensity of light associated with high beam headlights of vehicles. The OLED sheet 26 receives the off when the light camera 32 does not detect light above the pre-determined trigger intensity. The control unit 36 is electrically coupled to a power source comprising the vehicle 14's electrical system.

In use, the light camera 32 continuously monitors the intensity of light that is directed toward the windshield 12. Additionally, the eye camera 34 continuously monitors the direction of the driver's line of sight. The control unit 36 turns on selected sectors 22 of the dimming membrane 20 when the windshield 12 is exposed to the pre-determined trigger intensity of light. Moreover, the control unit 36 turns on the sector of the dimming membrane 20 that is positioned between the source of the light hitting the windshield 12 and the driver's line of sight. In this way the windshield 12 is dimmed only in the area through which the driver is looking. The control unit 36 turns off the sectors 22 of the dimming membrane 20 when the windshield 12 is not exposed to the pre-determined trigger intensity of light.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A windshield dimming assembly being configured to dim selected areas of a windshield with respect to a driver of a vehicle, said assembly comprising:
a windshield being positioned in a vehicle;
a dimming membrane being positioned within said windshield, said dimming membrane having a plurality of sectors therein, each of said sectors being translucent when said dimming membrane is turned off wherein said windshield is configured to pass light uninhibited through said windshield, selected ones of said sectors of said dimming membrane being opaque when said dimming membrane is turned on wherein said selected sectors are configured to protect a driver's eyes from bright light;
a light camera being coupled to the vehicle, said light camera being directed forwardly from the vehicle wherein said light camera is configured to detect light shining onto said windshield;
an eye camera being positioned within the vehicle, said eye camera being directed toward the driver's eyes wherein said eye camera is configured to record the driver's eyes; and
a control unit being coupled to the vehicle, each of said dimming membrane, said light camera and said eye camera being electrically coupled to said control unit, said control unit analyzing the light detected by said light camera, said control unit determining the driver's line of sight detected by said eye camera, said control unit turning on said selected sectors of said dimming membrane that correspond to the driver's line of sight.

2. The assembly according to claim 1, wherein:
said windshield has an outer pane and an inner pane; and
said dimming membrane is positioned between said inner pane and said outer pane.

3. The assembly according to claim 2, wherein said dimming membrane comprises an OLED sheet being positioned against said inner pane, said OLED sheet completely covering said inner pane, said OLED sheet receiving an off input and an on input, said OLED sheet being translucent when said OLED sheet receives said off input, said OLED sheet darkening when said OLED sheet receives said on input.

4. The assembly according to claim 3, wherein said dimming unit comprises a grid being positioned against said OLED sheet, said grid completely covering said OLED sheet, said grid being comprised of an electrically conductive material, said grid being in electrical communication with said OLED sheet, said grid defining said plurality of sectors.

5. The assembly according to claim 4, wherein said dimming unit comprises a polymeric sheet being positioned against said outer pane such that said grid is compressed between said OLED sheet and said polymeric sheet, said polymeric sheet being comprised of a translucent material, said polymeric sheet being comprised of a shatter resistant material.

6. The assembly according to claim 4, wherein each of said grid and said OLED sheet is electrically coupled to said control unit.

7. The assembly according to claim 6, wherein said control unit communicates said on input to said OLED sheet when said light camera detects light above a pre-determined trigger intensity.

8. The assembly according to claim 7, wherein said control unit communicating said off input to said OLED sheet when said light camera does not detect light about the pre-determined trigger intensity.

9. The assembly according to claim 8, wherein said control unit is electrically coupled to a power source comprising the vehicle's electrical system.

10. A windshield dimming assembly being configured to dim selected areas of a windshield with respect to a driver of a vehicle, said assembly comprising:
a windshield being positioned in a vehicle, said windshield having an outer pane and an inner pane;
a dimming membrane being positioned within said windshield, said dimming membrane having a plurality of sectors therein, each of said sectors being translucent when said dimming membrane is turned off wherein said windshield is configured to pass light uninhibited through said windshield, selected ones of said sectors of said dimming membrane being opaque when said dimming membrane is turned on wherein said selected sectors are configured to protect a driver's eyes from bright light, said dimming membrane being positioned between said inner pane and said outer pane, said dimming membrane comprising:
an OLED sheet being positioned against said inner pane, said OLED sheet completely covering said inner pane, said OLED sheet receiving an off input and an on input, said OLED sheet being translucent when said OLED sheet receives said off input, said OLED sheet darkening when said OLED sheet receives said on input;
a grid being positioned against said OLED sheet, said grid completely covering said OLED sheet, said grid being comprised of an electrically conductive material, said grid being in electrical communication with said OLED sheet, said grid defining said plurality of sectors; and
a polymeric sheet being positioned against said outer pane such that said grid is compressed between said OLED sheet and said polymeric sheet, said polymeric sheet being comprised of a translucent material, said polymeric sheet being comprised of a shatter resistant material;
a light camera being coupled to the vehicle, said light camera being directed forwardly from the vehicle wherein said light camera is configured to detect light shining onto said windshield;
an eye camera being positioned within the vehicle, said eye camera being directed toward the driver's eyes wherein said eye camera is configured to record the driver's eyes;
a control unit being coupled to the vehicle, each of said dimming membrane, said light camera and said eye camera being electrically coupled to said control unit, said control unit analyzing the light detected by said light camera, said control unit determining the driver's line of sight detected by said eye camera, said control unit turning on said selected sectors of said dimming membrane that correspond to the driver's line of sight, each of said grid and said OLED sheet being electrically coupled to said control unit, said control circuit communicating said on input to said OLED sheet when said light camera detects light above a trigger intensity, said OLED sheet receiving said off said control unit being electrically coupled to a power source comprising the vehicle's electrical system.
